(19) United States
(12) Patent Application Publication
(10) Pub. No.: US 2024/0127971 A1
(43) Pub. Date: Apr. 18, 2024

(54) Systems and methods for in-space fusion reactor cooling

(71) Applicant: Adam Priest, Huntersville, NC (US)

(72) Inventor: Adam Priest, Huntersville, NC (US)

(21) Appl. No.: 17/968,255

(22) Filed: Oct. 18, 2022

(51) Int. Cl. G21B 1/11; B64G 1/40; G21B 1/05

(52) U.S. Cl. CPC G21B 1/11; B64G 1/408; G21B 1/05

(57) ABSTRACT

A fusion reactor for a spacecraft adapted to be cooled by the resident temperatures in space. The fusion reactor includes a core containing fusion plasma and fuel, and a plurality of shaping coils adapted to contain and shape the fusion plasma and fuel. The fusion reactor including the core and the plurality of shaping coils are disposed within an outer structure of the spacecraft, and the shaping coils are adapted to be cooled by the resident temperatures in space.

### FIELD OF THE DISCLOSURE

The present disclosure relates generally to fusion reactor technology in spacecraft. More particularly, the present disclosure relates to systems and methods for in space fusion reactor cooling.

### BACKGROUND OF THE DISCLOSURE

Small fusion reactors are becoming more widely understood and desired to be used for powering and accelerating spacecraft. Direct Fusion Drive (DFD) is one of many emerging technologies that are being developed for future space missions. The fusion reactors contemplated for these endeavors utilize hot plasma for elements to fuse within to generate great amounts of energy. In these exemplary fusion reactors, the plasma is extremely hot and must be contained. Using magnetic forces to contain the plasma is a standard method known to those of skill in the art. Due to the incredibly hot temperatures of the plasma, and the need to keep the high powered magnets cool, current designs of electric circuits and magnets require temperatures near absolute zero to be sustained. To maintain these temperatures, a great amount of cooling is required. Typically, quenching is utilized to cool the components of these fusion reactors, requiring large amounts of gas or frozen solids to be injected into the plasma. The systems and methods presented in this disclosure eliminate the need for building a separate cooling apparatus for the fusion reactor, and instead utilizes the temperatures in space to automatically cool the components of the fusion reactor, and associated hardware.

The present background is provided as illustrative environmental context only. It will be readily apparent to those of ordinary skill in the art that the principles and concepts of the present disclosure may be implemented in other environmental contexts equally, without limitation.

### BRIEF SUMMARY OF THE DISCLOSURE

In an embodiment, a fusion reactor for a spacecraft adapted to be cooled by the resident temperatures in space includes: a core containing fusion plasma and fuel; and a plurality of shaping coils adapted to contain and shape the fusion plasma and fuel, wherein the core and the plurality of shaping coils are disposed within an outer structure of the spacecraft, and wherein the shaping coils are adapted to be cooled by the resident temperatures in space. The shaping coils can be high powered magnets adapted to contain and shape the fusion plasma and fuel. The shaping coils can contact the outer structure of the spacecraft at a plurality of contact points to dissipate heat from the shaping coils to the outer structure. Thermal interfacing material can be disposed at the contact points to optimize the heat dissipation between the shaping coils and the outer structure. The shaping coils can protrude through the outer structure of the spacecraft in order to be cooled by the resident temperatures of space. The outer structure of the spacecraft can include a plurality of louvers adapted for exposing components of the fusion reactor to space for cooling. The louvers can be positioned over the shaping coils for cooling the shaping coils. The louvers can be selectively actuated for cooling and managing temperatures of specific components of the fusion reactor. The fusion reactor can be one of a Direct Fusion Drive (DFD) fusion reactor and a Princeton Field-Reversed Configuration (PFRC) fusion reactor.

In another embodiment, a spacecraft includes an outer structure; and a fusion reactor, wherein the fusion reactor includes a core containing fusion plasma and fuel; and a plurality of shaping coils adapted to contain and shape the fusion plasma and fuel, wherein the core and the plurality of shaping coils are disposed within the outer structure of the spacecraft, and wherein the shaping coils are adapted to be cooled by the resident temperatures in space. The shaping coils can be high powered magnets adapted to contain and shape the fusion plasma and fuel. The shaping coils can contact the outer structure of the spacecraft at a plurality of contact points to dissipate heat from the shaping coils to the outer structure. Thermal interfacing material can be disposed at the contact points to optimize the heat dissipation between the shaping coils and the outer structure. The shaping coils can protrude through the outer structure of the spacecraft in order to be cooled by the resident temperatures of space. The outer structure of the spacecraft can include a plurality of louvers adapted for exposing components of the fusion reactor to space for cooling. The louvers can be positioned over the shaping coils for cooling the shaping coils. The louvers can be selectively actuated for cooling and managing temperatures of specific components of the fusion reactor. The fusion reactor can be one of a Direct Fusion Drive (DFD) fusion reactor and a Princeton Field-Reversed Configuration (PFRC) fusion reactor.

In a further embodiment, a method for cooling and maintaining temperatures of an in-space fusion reactor includes steps of operating a fusion reactor for any of powering a spacecraft and propelling a spacecraft; monitoring temperatures of one or more components of the fusion reactor; and actuating one or more louvers of the spacecraft to cool and manage temperatures of the one or more components of the fusion reactor. The one or more louvers can be selectively actuated to manage and cool specific components of the fusion reactor.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram of an exemplary Direct Fusion Drive (DFD) fusion reactor which may be used for spacecraft power and propulsion;

FIG. 2 is a diagram of a fusion reactor used for power and propulsion of a spacecraft;

FIG. 3 is a diagram of a fusion reactor used for power and propulsion of a spacecraft with shaping coils exposed to space;

FIG. 4 is a diagram of a fusion reactor used for power and propulsion of a spacecraft with shaping coils exposed to space by a plurality of louvers; and

FIG. 5 is a flow diagram of a process for cooling and maintaining temperatures of in-space fusion reactors.

### DETAILED DESCRIPTION OF THE DISCLOSURE

The present disclosure describes systems and methods for cooling an in-space fusion reactor and accompanying components on a spacecraft. The preset disclosure proposes a cooling system which utilizes the resident temperatures in space to cool and maintain an operating temperature of a fusion reactor. Current methods of cooling fusion reactors include intricate systems which introduce many complexities. The proposed embodiments described herein eliminate the complexities of current methods for cooling fusion reactors, which can prove to be vital for spacecraft.

Current and future fusion reactor technology will allow fusion reactors to produce very large amounts of energy. In addition, fusion reactors operating on spacecraft will need to operate for extended periods of time. Given the described scenarios, it is crucial to be able to both cool and maintain the temperatures of the fusion plasma and other components.

Current methods include injecting large quantities of gas or cryogenically frozen solid into the plasma, thus cooling the system. Various approaches have evolved into different methods such as injecting the gas or cryogenically frozen solid into the outer edge of the plasma allowing the system to cool from the outside. Additionally, various other approaches include injecting material, such as diamond shells, into the core of the plasma in an effort to cool the system from the inside.

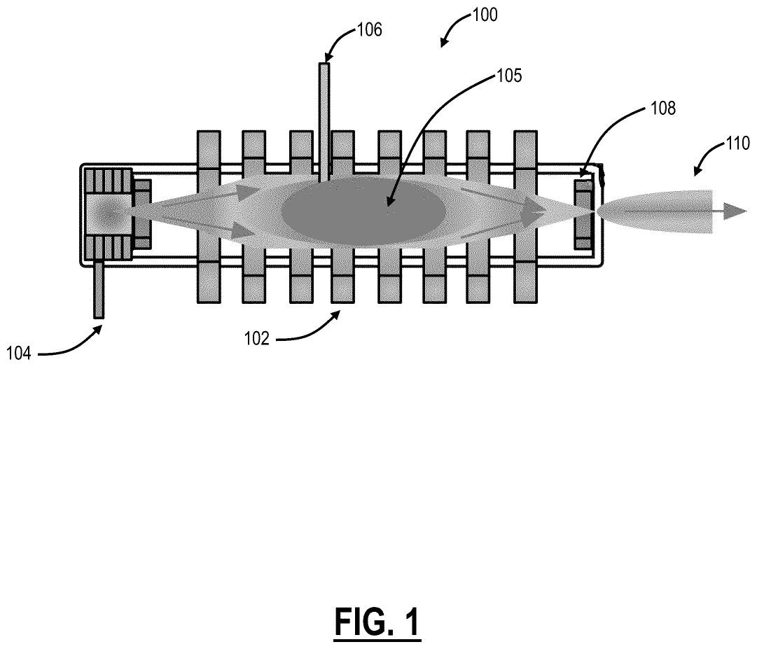

FIG. 1 is a diagram of an exemplary fusion reactor 100 which may be used for spacecraft power and propulsion. The fusion reactor in FIG. 1 is a Direct Fusion Drive (DFD) fusion reactor. The fusion reactor includes a plurality of shaping coils 102, propellant 104, and fuel 106. The shaping coils 102 can be arranged in a linear array as shown in FIG. 1 and can additionally be composed of an array of high powered magnets, or any magnetic field inducing device. In the present disclosure, the shaping coils 102 include coiled superconducting wires to produce the desired magnetic field. The superconducting wires must be cooled to very low temperatures during use. Various embodiments utilize superconducting wire as it has no resistance when in use at supercooled temperatures in addition to its ability to conduct very large electrical currents with little to no resistance to create the incredibly powerful magnetic fields needed for containment of the fusion plasma.

In various embodiments, the propellant 104 can be plasma while the fuel 106 can be a combination of Deuterium and Helium-3, or any other fuel known to one of skill in the art. The propellant 104 and fuel 106 combine in the core 105 of the fusion reactor 100. The DFD fusion reactor shown in FIG. 1 further includes an exhaust 110 shown as an open end of the DFD fusion reactor, and a nozzle coil 108. The nozzle coil 108 can similarly be made of a high powered magnet or any magnetic field inducing device such as the superconducting wires of the present disclosure. In various embodiments, the fusion reactor 100 can be closed at both ends, resembling a Princeton Field-Reversed Configuration (PFRC) fusion reactor. In a PFRC fusion reactor, the exhaust can be further cooled and recycled, while the DFD configuration utilizes the exhaust 110 as a rocket plume for propulsion. It will be appreciated that the present systems and methods can be adapted to be used with any fusion reactor configuration, and the DFD and PFRC fusion reactors described herein are non-limiting examples.

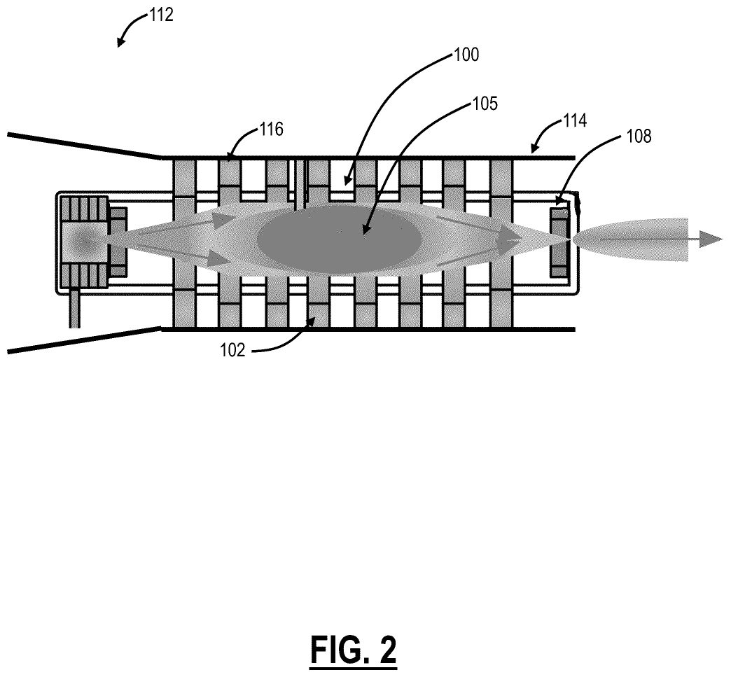

FIG. 2 is a diagram of a fusion reactor 100 used for power and propulsion of a spacecraft. Again, the fusion reactor 100 shown in FIG. 2 is a DFD fusion reactor which includes a plurality of shaping coils 102, propellant 104, and fuel 106. Additionally, the fusion reactor 100 of FIG. 2 is disposed within a spacecraft 112. The spacecraft 112 of the present disclosure can be adapted to perform any space mission known to one of skill in the art ranging from manned space missions to deep space missions. The spacecraft 112 includes an outer structure 114 acting as a barrier between any internal components of the spacecraft 112 and space.

In various embodiments, the shaping coils 102 are adapted to be cooled by the resident temperatures in space. In FIG. 2, the shaping coils 102 and outer structure 114 of the spacecraft 112 are positioned such that the shaping coils 102 are cooled by the temperatures in space. In embodiments, the shaping coils 102 make contact with the outer structure 114 at various contact points 116, such that the outer structure 114 can dissipate heat associated with the shaping coils 102 and the fusion reactor 100. The interface between the shaping coils 102 and outer structure 114 can further include various thermal interfacing materials known to one of skill in the art in order to optimize the heat dissipating abilities of the shaping coil 102 to outer structure 114 via the contact points 116.

Further, although not shown in the present figures, the nozzle coil 108 can additionally be cooled in the same manner as the shaping coils 102. In such embodiments, the nozzle coil 108 can make contact with the outer structure 114 of the spacecraft in order for the outer structure 114 to dissipate heat from the nozzle coil 108.

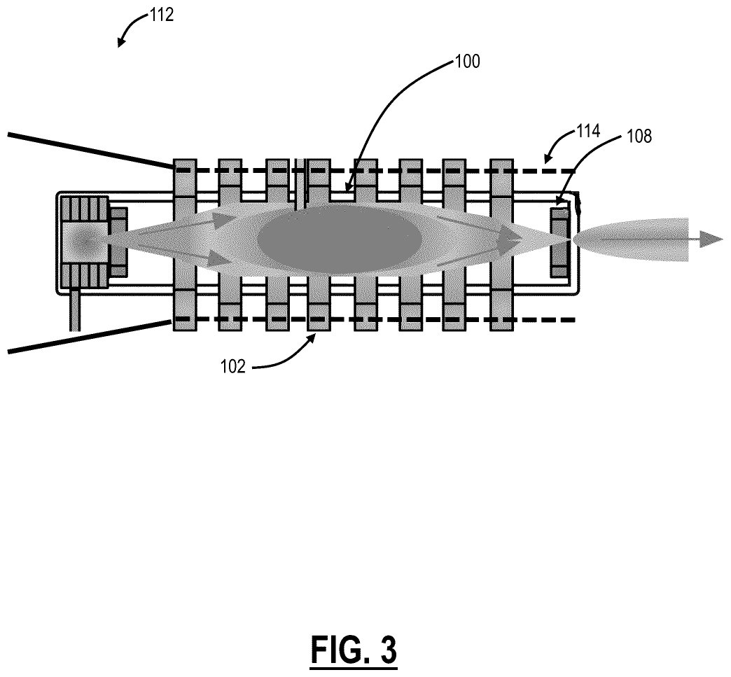

FIG. 3 is a diagram of a fusion reactor 100 used for power and propulsion of a spacecraft with shaping coils exposed to space. The fusion reactor 100 shown in FIG. 3 is disposed in a spacecraft 112. The spacecraft again includes an outer structure 114 acting as a barrier between any internal components of the spacecraft 112 and space. The fusion reactor 100 includes shaping coils 102 and other components disclosed in various other embodiments herein, wherein the shaping coils 102 are exposed to space.

In various embodiments, the shaping coils 102 of the fusion reactor 100 are adapted to be exposed to space through the outer structure 114 of the spacecraft 112. By exposing the shaping coils 102 to the temperatures in space, the temperature of the shaping coils 102 can be maintained at the desired supercooled temperatures. In embodiments, the shaping coils 102 protrude from the outer structure 114 of the spacecraft 112. It will be appreciated that the shaping coils 102 of the present embodiment can be any magnetic field inducing device including but not limited to high powered magnets. In embodiments where magnets are utilized, the magnets can protrude from the outer structure 114 of the spacecraft in order to be cooled by space.

Further, although not shown in the present figures, the nozzle coil 108 can additionally be cooled in the same manner as the shaping coils 102. In such embodiments, the nozzle coil 108 can protrude from the outer structure 114 of the spacecraft in order to be cooled by space.

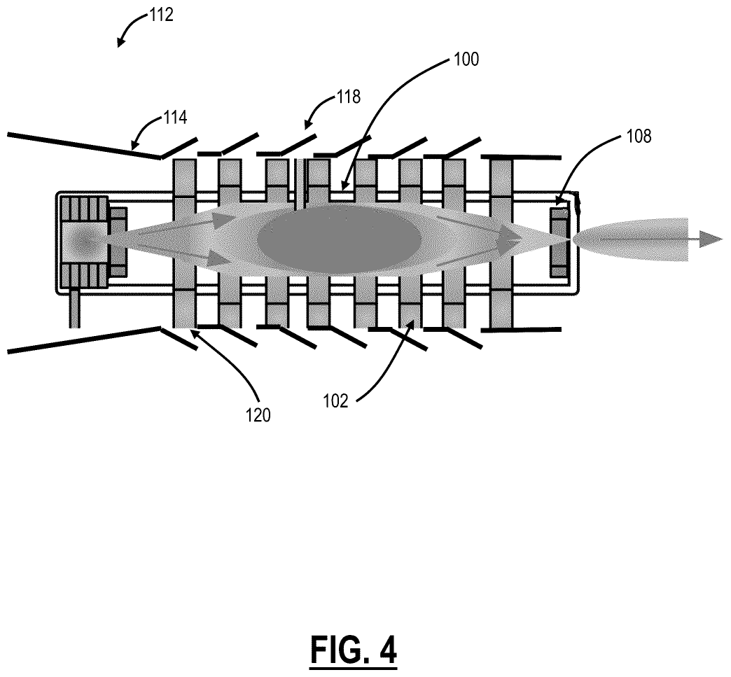

FIG. 4 is a diagram of a fusion reactor 100 used for power and propulsion of a spacecraft 112 with shaping coils 102 exposed to space by a plurality of louvers 118. The fusion reactor 100 again includes a plurality of shaping coils 102 used to shape and contain the plasma of the fusion reactor 100. The spacecraft 112 of FIG. 4 includes an outer structure 114. The outer structure 114 further includes a plurality of louvers 118 adapted to allow the shaping coils 102 of the fusion reactor 100 to be cooled by space.

In various embodiments, the louvers 118 are movable (i.e., adapted to be opened or closed) and configurable to manage the cooling and temperature of the fusion reactor 100. Embodiments can include automatic configurable louvers 118 which can automatically configure themselves based on the cooling need by the fusion reactor 100. Other embodiments can include manually configurable louvers 118 which can be controlled remotely.

In various embodiments, the louvers 118 include louver openings 120 which allow specific components of the fusion reactor 100 to be selectively exposed to space. These embodiments can further include louvers 118 and louver openings 120 which are aligned with the shaping coils 102 to selectively expose the shaping coils 102 to space in order to focus the cooling on the shaping coils 102. Some embodiments can include louvers 118 which can be individually and selectively actuated (i.e., opened or closed) to expose one or more shaping coils 102 or other components of the fusion reactor 100 as needed, either automatically or manually.

Further, although not shown in the present figures, the nozzle coil 108 can additionally be cooled in the same manner as the shaping coils 102. In such embodiments, the louvers 118 can extend to the nozzle coil 108 and include louver openings 120 aligned with the nozzle coil 108 to expose the nozzle coil 108 to space for cooling.

It will be appreciated that the cooling systems and methods disclosed herein can be utilized to cool any component of a spacecraft. Further, the DFD fusion reactor shown in the figures can be replaced by a PFRC fusion reactor, or any other fusion reactor type or configuration known to one of ordinary skill in the art. Thus, the embodiments discussed in the present disclosure shall be contemplated as non-limiting examples.

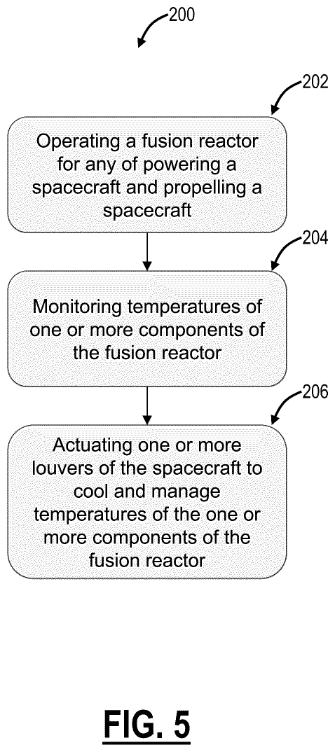

FIG. 5 is a flow diagram of a process 200 for cooling and maintaining temperatures of in-space fusion reactors. The process 200 can be performed manually, or be a computer-implemented method and as instructions stored in a non-transitory computer readable medium performed by onboard computers of a spacecraft. The method of cooling and maintaining temperatures of an in-space fusion reactor includes the steps of operating a fusion reactor for any of powering a spacecraft and propelling a spacecraft (step 202), monitoring temperatures of one or more components of the fusion reactor (step 204), and actuating one or more louvers of the spacecraft to cool and manage temperatures of the one or more components of the fusion reactor (step 206). The process 200 can further include wherein the one or more louvers are selectively actuated to manage and cool specific components of the fusion reactor. The process 200 can be either manually performed, or automatically carried out by existing onboard computing systems of the spacecraft, wherein the steps are performed based on logic adapted to facilitate the steps disclosed herein. For example, the logic can include monitoring the temperatures of one or more components of the fusion reactor and actuating the one or more louvers of the spacecraft to cool and manage temperatures of the one or more components of the fusion reactor. The logic can further include algorithms for determining when specific components of the fusion reactor may require further cooling, etc.

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A fusion reactor for a spacecraft adapted to be cooled by the resident temperatures in space, the fusion reactor comprising:
a core containing fusion plasma and fuel; and
a plurality of shaping coils adapted to contain and shape the fusion plasma and fuel, wherein the core and the plurality of shaping coils are disposed within an outer structure of the spacecraft, and wherein the shaping coils are adapted to be cooled by the resident temperatures in space.

2. The fusion reactor of claim 1, wherein the shaping coils are high powered magnets adapted to contain and shape the fusion plasma and fuel.

3. The fusion reactor of claim 1, wherein the shaping coils contact the outer structure of the spacecraft at a plurality of contact points to dissipate heat from the shaping coils to the outer structure.

4. The fusion reactor of claim 3, wherein thermal interfacing material is disposed at the contact points to optimize the heat dissipation between the shaping coils and the outer structure.

5. The fusion reactor of claim 1, wherein the shaping coils protrude through the outer structure of the spacecraft in order to be cooled by the resident temperatures of space.

6. The fusion reactor of claim 1, wherein the outer structure of the spacecraft comprises a plurality of louvers adapted for exposing components of the fusion reactor to space for cooling.

7. The fusion reactor of claim 6, wherein the louvers are positioned over the shaping coils for cooling the shaping coils.

8. The fusion reactor of claim 6, wherein the louvers are selectively actuated for cooling and managing temperatures of specific components of the fusion reactor.

9. The fusion reactor of claim 1, wherein the fusion reactor is one of a Direct Fusion Drive (DFD) fusion reactor and a Princeton Field-Reversed Configuration (PFRC) fusion reactor.

10. A spacecraft comprising:
an outer structure; and
a fusion reactor, wherein the fusion reactor comprises
a core containing fusion plasma and fuel; and
a plurality of shaping coils adapted to contain and shape the fusion plasma and fuel, wherein the core and the plurality of shaping coils are disposed within the outer structure of the spacecraft, and wherein the shaping coils are adapted to be cooled by the resident temperatures in space.

11. The spacecraft of claim 10, wherein the shaping coils are high powered magnets adapted to contain and shape the fusion plasma and fuel.

12. The spacecraft of claim 10, wherein the shaping coils contact the outer structure of the spacecraft at a plurality of contact points to dissipate heat from the shaping coils to the outer structure.

13. The spacecraft of claim 12, wherein thermal interfacing material is disposed at the contact points to optimize the heat dissipation between the shaping coils and the outer structure.

14. The spacecraft of claim 10, wherein the shaping coils protrude through the outer structure of the spacecraft in order to be cooled by the resident temperatures of space.

15. The spacecraft of claim 10, wherein the outer structure of the spacecraft comprises a plurality of louvers adapted for exposing components of the fusion reactor to space for cooling.

16. The spacecraft of claim 15, wherein the louvers are positioned over the shaping coils for cooling the shaping coils.

17. The spacecraft of claim 15, wherein the louvers are selectively actuated for cooling and managing temperatures of specific components of the fusion reactor.

18. The spacecraft of claim 10, wherein the fusion reactor is one of a Direct Fusion Drive (DFD) fusion reactor and a Princeton Field-Reversed Configuration (PFRC) fusion reactor.

19. A method for cooling and maintaining temperatures of an in-space fusion reactor, the method comprising steps of:
operating a fusion reactor for any of powering a spacecraft and propelling a spacecraft;
monitoring temperatures of one or more components of the fusion reactor; and
actuating one or more louvers of the spacecraft to cool and manage temperatures of the one or more components of the fusion reactor.

20. The method of claim 19 wherein the one or more louvers are selectively actuated to manage and cool specific components of the fusion reactor.
